(19) United States
(12) Patent Application Publication
(10) Pub. No.: US 2025/0270369 A1
(43) Pub. Date: Aug. 28, 2025

(54) MODIFIED CYANOPHYCIN

(71) Applicant: Eberhard Karls Universität Tübingen, Tübingen (DE)

(72) Inventors: Björn WATZER, Tübingen (DE); Karl FORCHHAMMER, Tübingen (DE)

(21) Appl. No.: 18/701,080

(22) PCT Filed: Oct. 12, 2022
(86) PCT No.: PCT/EP2022/078414

§ 371 Date: Apr. 12, 2024

(30) Foreign Application Priority Data
Oct. 12, 2021 (DE) 10 2021 126 431.6

(51) Int. Cl. C08G 69/46; A61K 47/34; C09D 177/02; C12N 15/88

(52) U.S. Cl. CPC C08G 69/46; A61K 47/34; C09D 177/02; C12N 15/88

(57) ABSTRACT

The invention relates to a process for esterifying cyanophycin with various alcohols, to esterified cyanophycin, and to various uses and compositions of the processes and products described in the invention.

### FIELD OF THE INVENTION

The invention relates to a process for esterifying cyanophycin with various alcohols, to esterified cyanophycin, and to various uses and compositions of the processes and products described in the invention.

### DESCRIPTION

Cyanophycin (also known as CGP: cyanophycin granule polypeptide) was discovered by Borzi in 1887 during microscopic studies on cyanobacteria (Borzi, 1887) and was later found in all species of cyanobacteria (Oppermann-Sanio et al., 2003). The CGP molecular structure is related to that of poly(aspartic acid), but unlike synthetic polyaspartic acid, it is a comb-like polymer with α-amino-α-carboxy-linked L-aspartic acid residues forming the backbone of the polymer and L-arginine residues attached to the β-carboxyl groups of aspartic acids. Cyanophycin isolated from cyanobacteria is highly polydisperse and shows a molecular weight range of approximately 25-100 kDa on SDS gels, which corresponds to a degree of polymerization of 90-400.

The biosynthesis of cyanophycin was extensively studied by Simon and colleagues in the 1970s (Simon, 1971; Simon and Weathers, 1973; Simon and Weathers, 1976; Simon, 1973; Simon, 1976), which led to the identification of the enzymes involved in cyanophycin synthesis. These synthetases and the genes coding for the enzymes (cphA) can be found in various organisms (Ziegler et al., 1998; Aboulmagd et al., 2000; Berg et al., 2000; Hai et al., 2002).

Cyanophycin is a biodegradable poly-electrolyte with a poly-dispersity of 20 to 100 kDa (equivalent to 70 to 350 Arg-Asp repeating units). Polyelectrolytes have a wide range of applications in the polymer industry or pharmaceuticals. Polyelectrolytes can be used, for example, as superabsorbents, flocculants or by layer-by-layer methods for the surface modification of solids. In medicine or pharmacy, they are used as carriers or excipients. Cyanophycin can also be used as a polycation due to its positively charged guanidine group. Polycations that are already used in industry: Poly (allylamine), poly-(I-lysine), poly(ethyleneimine), poly(dimethyldiallylammonium chloride), poly(allylamine hydrochloride) or chitosan.

Although cyanophycin would be an extremely interesting biopolymer for various industrial applications, its handling is generally difficult due to its solubility. Native cyanophycin is insoluble between pH 2.5 to 8 and at pH 12.5. The reason for this is the charge of the polymer: At neutral pH, cyanophycin is present as a Zwitterion, which reduces its solubility in water.

It is thus an object of the invention to provide a new derivative cyanophycin that overcomes the above-mentioned difficulties in handling the biopolymer and thus makes cyanophycin accessible for industrial use.

### BRIEF DESCRIPTION OF THE INVENTION

The object of the invention is achieved by esterification of the carboxy group of the arginine of cyanophycin, with the result that cyanophycin is no longer present as a zwitterion and thus becomes soluble at neutral pH. In addition, new properties can be introduced into a cyanophycin polymer by using specific alcohols (hydrophilic or hydrophobic, monovalent or polyvalent). The invention is described in the following brief description of the individual aspects of the invention:

In a first aspect, the invention relates to a method for producing an ester of a cyanophycin polymer or an ester of a cyanophycin polymer derivative, comprising reacting the cyanophycin polymer or the cyanophycin polymer derivative with an alcohol (HO—X) to form an ester of a cyanophycin polymer or an ester of a cyanophycin polymer derivative, and water, under reaction conditions that permit esterification of the alcohol with at least the carboxyl group of a cyanophycin monomer, wherein the at least one cyanophycin monomer is a component of the cyanophycin polymer or the cyanophycin polymer derivative.

In a second aspect, the invention relates to an ester of a cyanophycin polymer, in accordance with a structure of formula (II) with n>2, preferably with n>10, further preferably with n=50-500 (or 70-350):

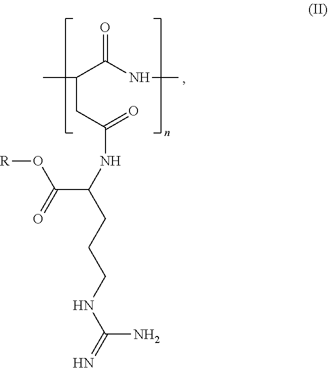

wherein R is selected from a primary, secondary or tertiary alcohol, and/or monohydric or polyhydric alcohols, preferably selected from one of the following residues, wherein m is a natural number >0:

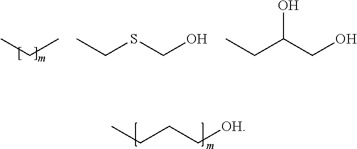

In a third aspect, the invention relates to a use of the ester of a cyanophycin polymer in accordance with the preceding aspects, in the production of a pharmaceutical composition, for example as a carrier and/or excipient.

In a fourth aspect, the invention relates to a pharmaceutical composition comprising a therapeutically active ingredient and an ester of a cyanophycin polymer in accordance with the second aspect, and, preferably, at least one further carrier and/or excipient.

In a fifth aspect, the invention relates to a use of the ester of a cyanophycin polymer in accordance with the preceding aspects of the invention, in the insertion of a nucleic acid into a biological cell (hereinafter referred to as: transfection).

In a sixth aspect, the invention relates to a transfection agent, or a transfection composition, comprising an ester of a cyanophycin according to the invention.

In a seventh aspect, the invention relates to a transfection kit comprising the transfection agent of the invention, and optionally, a further buffer or means for performing a transfection.

In an eighth aspect, the invention relates to a use of the ester of a cyanophycin polymer according to the invention as:
an ion exchanger, particularly as a stationary phase in ion exchange chromatography; or
a coating material, preferably for nanoparticles; or
in polymer alloys, polymer blends or copolymers; or
as a component of polyelectrolyte multilayers (PEMs); or
in a polyelectrolyte bridging method.

### DETAILED DESCRIPTION OF THE INVENTION

The detailed aspects of the invention are described below. These aspects are set forth with specific embodiments, but the description should be understood to mean that these embodiments may be combined in any manner and in any number, which are further embodiments of the invention. The various examples and preferred embodiments described herein are not to be construed as limiting the present invention to only those embodiments expressly described. The description should be understood to support and comprise embodiments that combine two or more of the specifically described embodiments, or that combine one or more of the specifically described embodiments with any number of the disclosed and/or preferred aspects.

In a first aspect, the invention relates to a method for producing an ester of a cyanophycin polymer or an ester of a cyanophycin polymer derivative, comprising reacting the cyanophycin polymer or the cyanophycin polymer derivative with an alcohol (HO—X) to form an ester of a cyanophycin polymer or an ester of a cyanophycin polymer derivative, and water, under reaction conditions that permit esterification of the alcohol with at least the carboxyl group of a cyanophycin monomer, wherein the at least one cyanophycin monomer is a component of the cyanophycin polymer or the cyanophycin polymer derivative.

In the context of the present text, the term “esterification” is used for all reactions mentioned here for producing cyanophycin esters. The term “esterification” therefore covers both the reaction of an acid with an alcohol (esterification) and the reaction of an alcohol with an ester (transesterification). In a preferred method according to the invention, a cyanophycin is esterified with an alcohol in the presence of an acid (“Fischer esterification”). Thus, it is particularly preferred that the reaction of the method according to the invention is performed in the presence of an acid, preferably sulfuric acid.

The esters provided by means of the method are accessible for transesterification according to the invention. Accordingly, in an alternative first aspect, the present invention relates to a method for producing an ester of a cyanophycin polymer or an ester of a cyanophycin polymer derivative, comprising reacting a starting ester of a cyanophycin polymer or a starting ester of a cyanophycin polymer derivative with an alcohol (HO—X) to form a new ester of the cyanophycin polymer or ester of a cyanophycin polymer derivative, under reaction conditions that allow transesterification of the alcohol with the alcohol residue of the starting ester of the cyanophycin monomer or a starting ester of a cyanophycin polymer derivative.

The term “ester of a cyanophycin polymer” or “ester of a cyanophycin polymer derivative”, in the context of the present disclosure, is intended to comprise all esters of cyanophycin that are esterified with an alcohol at the free carboxyl group of the arginine residue. Particularly comprised are polymers of cyanophycin in which at least one arginine side chain (a monomer) is esterified according to the invention, further preferably at least two side chains, further preferably at least three arginine side chains, further preferably at least 5 side chains, further preferably at least 9 side chains, further preferably at least 10, 15, 30, at least 50 or more side chains. Here, the side chains of a polymer may well be esterified with different alcohols according to the invention.

In a particularly preferred embodiment of the invention, a method is provided wherein at least two cyanophycin monomers are esterified with different alcohols within the cyanophycin polymer or cyanophycin polymer derivative. In an alternative embodiment of the method, the cyanophycin monomers of a polymer are esterified with the same alcohol.

For the present disclosure, a cyanophycin polymer is a molecule having the structure (I), with n>2, preferably with n>8, more preferably with n=50-500 (or more preferably 70-350):

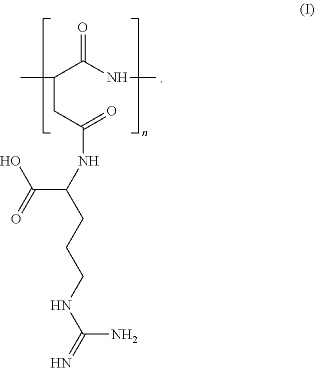

In the context of the present disclosure, in particular the alcohol HO—X is to be selected from a primary alcohol, such as methanol, ethanol or 1-propanol; mercaptoethanol, glycerol or a polyethylene glycol (PEG), or other secondary or tertiary alcohols, and/or monohydric or polyhydric alcohols.

Particularly preferred alcohols for use in connection with the present disclosure are listed in Table 1 below and represent preferred embodiments of the invention individually but also in combination:

TABLE 1
Alcohols suitable and preferred for use in the present invention:

| | | | |
|---|---|---|---|
| | | Empirical | CAS Registry |
| Number | CAS name | formula | Number |

Monohydric linear alcohols

| | | | |
|---|---|---|---|
| 1 | Methanol | CH₄O | 67-56-1 |
| 2 | Ethanol | C₂H₆O | 64-17-5 |
| 3 | 1-propanol | C₃H₈O | 71-23-8 |
| 4 | 1-butanol | C₄H₁₀₀ | 71-36-3 |
| 5 | 1-pentanol | C₅H₁₂₀ | 71-41-0 |
| 6 | 1-hexanol | C₆H₁₄₀ | 111-27-3 |
| 7 | 1-heptanol | C₇H₁₆O | 111-70-6 |
| 8 | 1-octanol | C₈H₁₈₀ | 111-87-5 |
| 9 | 1-nonanol | C₉H₂₀O | 143-08-8 |
| 10 | 1-decanol | C₁₀H₂₂O | 112-30-1 |
| 11 | 1-undecanol | C₁₁H₂₄O | 112-42-5 |
| 12 | 1-dodecanol | C₁₂H₂₆O | 112-53-8 |
| 13 | 1-tridecanol | C₁₃H₂₈O | 112-70-9 |
| 14 | 1-tetradecanol | C₁₄H₃₀O | 112-72-1 |
| 15 | 1-pentadecanol | C₁₅H₃₂O | 629-76-5 |
| 16 | 1-hexadecanol | C₁₆H₃₄O | 36653-82-4 |
| 17 | 1-octadecanol | C₁₈H₃₈O | 112-92-5 |
| 18 | 1-hexacosanol | C₂₆H₅₄O | 506-52-5 |
| 19 | 1-triacontanol | C₃₀H₆₂O | 593-50-0 |

Secondary/tertiary primary alcohols

| | | | |
|---|---|---|---|
| 20 | Isopropanol | C₃H₈O | 67-63-0 |
| 21 | 2-butanol | C₄H₁₀O | 78-92-2 |
| 22 | Isobutanol | C₄H₁₀O | 78-83-1 |
| 23 | tert-butanol | C₄H₁₀O | 75-65-0 |
| 24 | 2-pentanol | C₅H₁₂O | 6032-29-7 |
| 25 | 3-pentanol | C₅H₁₂O | 584-02-1 |
| 26 | 2-methyl-1-butanol | C₅H₁₂O | 137-32-6 |
| 27 | Isoamyl alcohol | C₅H₁₂O | 123-51-3 |
| 28 | 2-methyl-2-butanol | C₅H₁₂O | 75-85-4 |
| 29 | 3-methyl-2-butanol | C₅H₁₂O | 598-75-4 |
| 30 | Neopentyl alcohol | C₅H₁₂O | 75-84-3 |
| 31 | Allyl alcohol | C₃H₆O | 107-18-6 |
| 32 | 2-buten-1-ol | C₄H₈O | 6117-91-5 |
| 33 | 3-butyn-1-ol | C₄H₆O | 927-74-2 |
| 34 | 2-hexyn-1-ol | C₆H₁₀O | 764-60-3 |
| 35 | 3-hexyn-1-ol | C₆H₁₀O | 1002-28-4 |
| 36 | 3-hexyn-2-ol | C₆H₁₀O | 109-50-2 |
| 37 | 5-hexyn-3-ol | C₆H₁₀O | 19780-84-8 |
| 38 | 3-octyn-1-ol | C₈H₁₄O | 14916-80-4 |
| 39 | 7-octyn-1-ol | C₈H₁₄O | 871-91-0 |
| 40 | 3-decanol | C₁₀H₂₂O | 1565-81-7 |
| 41 | 4-decanol | C₁₀H₂₂O | 2051-31-2 |

Polyhydric alcohols

| | | | |
|---|---|---|---|
| 42 | Ethylene glycol | C₂H₆O₂ | 107-21-1 |
| 43 | Propylene glycol | C₃H₈O₂ | 57-55-6 |
| 44 | 1,3-propanediol | C₃H₈O₂ | 504-63-2 |
| 45 | 1,2-butanediol | C₄H₁₀O₂ | 584-03-2 |
| 46 | 1,3-butanediol | C₄H₁₀O₂ | 107-88-0 |
| 47 | 1,4-butanediol | C₄H₁₀O₂ | 110-63-4 |
| 48 | 2,3-butanediol | C₄H₁₀O₂ | 513-85-9 |
| 49 | 1,5-pentanediol | C₅H₁₂O₂ | 111-29-5 |
| 50 | 1,6-hexanediol | C₆H₁₄O₂ | 629-11-8 |
| 51 | 1,8-octanediol | C₈H₁₈O₂ | 629-41-4 |
| 52 | 1,9-nonanediol | C₉H₂₀O₂ | 3937-56-2 |
| 53 | 1,10-decanediol | C₁₀H₂₂O₂ | 112-47-0 |
| 54 | Glycerol | C₃H₈O₃ | 56-81-5 |
| 55 | Polyethylene glycol | (C₂H₄O)nH₂O | 25322-68-3 |
| 56 | Thiodiglycol | C₄H₁₀O₂S | 111-48-8 |

Cyclic and aromatic alcohols

| | | | |
|---|---|---|---|
| 57 | Cyclopentanol | C₅H₁₀O | 96-41-3 |
| 58 | Phenol | C₆H₆O | 108-95-2 |
| 59 | Cyclohexanol | C₆H₁₂O | 108-93-0 |
| 60 | Benzyl alcohol | C₇H₈O | 100-51-6 |
| 61 | Cyclohexanemethanol | C₇H₁₄₀ | 100-49-2 |
| 62 | 1-phenylethanol | C₈H₁₀₀ | 98-85-1 |
| 63 | 2-phenylethanol | C₈H₁₀O | 60-12-8 |
| 64 | Benzhydrol | C₁₃H₁₂O | 91-01-0 |
| 65 | 1-naphthol | C₁₀H₈O | 90-15-3 |

A particularly preferred method relates to esterification according to the invention with the use of a polyethylene glycol (PEG). The term polyethylene glycol (PEG, macrogol) is used here to designate a condensation polymer of ethylene oxide and water with the general formula HO—(CH2—CH2—O)n —H. The low-molecular weight representatives from n=2 to n=4 are diethylene glycol, triethylene glycol and tetraethylene glycol. Where appropriate, the abbreviation (PEG) is used in combination with a numerical suffix indicating the average molecular weight of the PEG. The various forms of PEG are differentiated according to their molecular weight (low: 200-1500 D; high: >1500 D). However, short-chain PEGs with n in the range of 2 to 20 are particularly preferred in the context of the invention.

A prepared ester of the cyanophycin polymer thus preferably has the following structure II, with n>2, preferably with n>10, more preferably with n=50-500 (or 70-350):

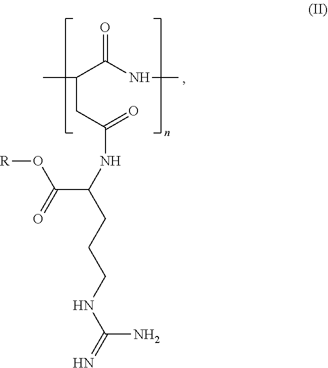

wherein R═X.

Another embodiment of the method of the invention relates to the following esterification reaction conditions:
A reaction temperature of 50° C. to 120° C., preferably 65° C. to 90° C., more preferably approximately 70° C. to approximately 80° C.; and/or.
That the reaction is performed with constant stirring.

Subsequent to the esterification according to the invention, in a particularly preferred embodiment, the method may comprise a further step of purifying the ester of a cyanophycin polymer or the ester of a cyanophycin polymer derivative. Purification by precipitation, such as cold precipitation, or purification by means of dialysis is particularly preferred.

Another embodiment of the method according to the invention, which is preferred, relates to esterification wherein the cyanophycin polymer has at least nine or more monomers, and wherein the reaction conditions are selected in such a way that at least the carboxyl groups of nine or more monomers are esterified, preferably more than 50% of the carboxyl groups are esterified.

In a second aspect, the invention relates to an ester of a cyanophycin polymer, in accordance with a structure of formula (II) with n>2, preferably with n>10, further preferably with n=50-500 (or 70-350):

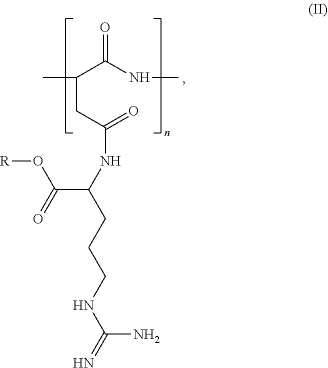

wherein R is selected from a primary, secondary or tertiary alcohol and/or monohydric or polyhydric alcohols.

Particularly preferably, R is an alcohol selected from Table 1, and further preferably selected from one of the following residues, wherein m is a natural number >0:

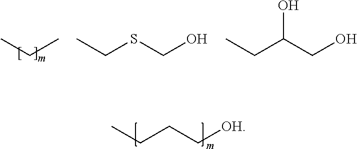

In an alternative second aspect, an ester of a cyanophycin according to the invention comprises at least two dipeptide monomers having different alcohol chains esterified at the arginine carboxyl chains according to the invention. Such mixed polymer esters can be obtained, for example, by using alcohol mixtures during esterification. The different monomers can occur completely randomly in the cyanophycin polymer. Such mixed polymers are conceivable with further preferably at least 3, 4, 5, 6, 7 or more different alcohol contents.

According to the present invention, such an ester of a cyanophycin polymer is said to be producible, and/or to have been produced, by a method according to the first aspect of the invention.

Preferred is an ester of a cyanophycin polymer which has completely, or substantially completely, i.e. at least 80%, preferably 90%, 95%, or 99% esterified carboxyl groups.

It is also preferred that an ester of a cyanophycin polymer is purely cationic according to the invention—i.e. preferably not present as a hermaphroditic ion. In particular, an ester of a cyanophycin polymer according to the invention may have an increased solubility compared to a cyanophycin polymer, which is identical in chain length but unesterified.

Further preferred in the context of the invention is a PEG ester of a cyanophycin polymer.

A particularly preferred embodiment of the invention relates to a propyl ester of a cyanophycin polymer according to the present invention (propyl-CP). Further aspects of the invention of a propyl-CP relate to its use as an adhesion agent, particularly as a cell adhesion agent. Furthermore, the present invention relates to the use of an ester in accordance with a cyanophycin polymer according to the invention as an antibacterial substance. For example, in the context of a sterilization device. Conceivable embodiments therefore relate to a protective device treated with an ester of a cyanophycin polymer according to the invention (such as a mouth-nose cover, or another type of cover for sterile packaging or compartmentalization).

In a third aspect, the invention relates to a use of the ester of a cyanophycin polymer in accordance with the preceding aspects, in the production of a pharmaceutical composition, for example as a carrier and/or excipient.

In a fourth aspect, the invention relates to a pharmaceutical composition comprising a therapeutically active ingredient and an ester of a cyanophycin polymer in accordance with the second aspect, and, preferably, at least one further carrier and/or excipient.

In a fifth aspect, the invention relates to a use of the ester of a cyanophycin polymer in accordance with the preceding aspects of the invention, in the introduction of a nucleic acid into a biological cell (hereinafter referred to as: transfection).

In a sixth aspect, the invention relates to a transfection agent, or a transfection composition, comprising an ester of a cyanophycin according to the invention.

In a seventh aspect, the invention relates to a transfection kit comprising the transfection agent of the invention, and optionally, a further buffer or means for performing a transfection.

In the above aspects in the context of a transfection, an ester of a cyanophycin polymer according to the invention is used as in combination with a further transfection agent, for example with a lipid particle-based means, such as lipofectamine. It is particularly preferred to use an ethyl ester of a cyanophycin in the above aspects of the invention.

In an eighth aspect, the invention relates to a use of the ester of a cyanophycin polymer according to the invention as:
an ion exchanger, particularly as a stationary phase in ion exchange chromatography; or
a coating material, preferably for nanoparticles; or
a component in polymer alloys, polymer blends or copolymers; or
a component of polyelectrolyte multilayers (PEMs); or
a component in a polyelectrolyte bridging method.

The expressions “of the [present] invention”, “in accordance with the invention”, “according to the invention” and the like used herein are intended to refer to all aspects and embodiments of the invention described and/or claimed herein.

As used herein, the term “comprising” should be understood to encompass both “including” and “consisting of”, wherein both meanings are expressly intended, and therefore represent individually disclosed embodiments in accordance with the present invention. In the context of the present invention, the terms “about” and “approximate” or “approximately” denote an accuracy interval that the person skilled in art understands to mean that the technical effect of the feature in question is still guaranteed. The term typically refers to a deviation from the specified numerical value of +20%, +15%, +10% and, for example, +5%. As will be clear to the person skilled in art, the specific deviation of a numerical value for a determined technical effect depends on the type of technical effect. For example, a natural or biological effect may generally have a greater deviation than a man-made or technical effect. The specific deviation of a numerical value for a determined technical effect depends on the type of technical effect.

### BRIEF DESCRIPTION OF THE FIGURES

The figures show:

FIG. 1 shows a schematic setup for the esterification of cyanophycin. Left for alcohols with boiling temperatures above 100° C. and right for alcohols with boiling temperatures below 100° C.

FIG. 2 shows a horizontal native polyacrylamide gel electrophoresis (PAGE). 40 μg of polymer was applied per lane. For EtOH-CP/DNA, 40 μg of genomic dsDNA was added. IEF marker is a protein marker for isoelectric focusing, taken because it does not contain SDS.

FIG. 3 shows an isoelectric focusing of cyanophycin and the water-soluble cyanophycin esters. A) IEF gel with “normal running direction” towards the anode. With this running direction, only native cyanophycin and the marker can run into the gel. B) Photo of the samples in the gel pockets. The cyanophycin esters form a white streak and run towards the cathode. C) IEF gel with reversed polarity. In this direction, only the cyanophycin esters can enter the gel. D) Photo of the samples in the gel pockets with reversed polarity. The loading dye (neutral red) runs in the opposite direction. The dye flows into the anode buffer, which has an acidic pH. Neutral red acts as a pH indicator and changes its color from red to yellow.

FIG. 4 shows SDS-PAGE of native cyanophycin (CP) and PEGylated cyanophycin (PEG CP). 20 and 40 μg per bag were loaded.

FIG. 5 shows an example in which 0.05% propyl CP in water liquid film was applied to a glass plate. Bacterial cells are then coated and fixed (similar to polylysine-coated surfaces). Sub-figure A shows a microscopic image of the fixation of the cells before washing, FIG. 5B shows an image after washing once, and FIG. 5C after washing twice.

FIG. 6 shows a determination of airborne microorganisms after air saturated with spores was passed through a layer of non-woven material treated with propyl CP; A: 10% propyl CP removes all spores; B: even after 1 week, the bottle remains sterile.

FIG. 7 shows an endpoint measurement of antimicrobial activity in the presence of propyl CP ester; several indicated strains were inoculated at different concentrations of propyl CP (P—CPH) in M9 medium; negative control, black bar: without an additive, positive control: Addition of an antibiotic, chloramphenicol (CM); after overnight incubation, the optical density of the culture was determined to identify bacterial growth. The figure at the end shows the control. The data columns correspond in order from left to right (in each illustration) to the legend from top to bottom.

FIG. 8 shows the growth of the E. coli culture in the presence of different concentrations of propyl CP ester. Controls: No addition (black) or antibiotic chloramphenicol (CM). Shown are growth curves with propyl CP concentrations from 10 to 150 μg/ml in steps of 10.

FIG. 9 shows a growth comparison of different bacteria in the presence of propyl CP (P—CPH) or polylysine (PL).

### EXAMPLES

Certain aspects and embodiments of the invention will now be explained by way of examples and with reference to the descriptions, figures and tables contained herein. Such examples of the methods, uses and other aspects of the present invention are representative only and should not be construed as limiting the scope of the present invention to only such representative examples.

The examples show:

### Example 1: Chemicals, laboratory devices, laboratory equipment and set-up

Cyanophycin (anhydrous)
[L-Asp (4-L-Arg)] n/CAS No. 213250-52-3
Molecular weight 20-100 kDa, extracted from Synechocystis sp. PCC 6803
Purity >90%
Concentrated sulphuric acid (≥96%)
H₂SO₄/CAS No. 7664-93-9

Alcohols:
Methanol, CH₃OH, CAS No. 67-56-1
Ethanol, C₂H₅OH, CAS No. 64-17-5
Propanol, C₃H₈O, CAS No. 71-23-8
Butanol, C₄H₁₀O, CAS No. 71-36-3
Octanol, C₈H₁₈₀, CAS No. 111-87-5
Phenol, C₆H₆O, CAS No. 108-95-2
Polyethylene glycol, (C₂H₄O) n, CAS No. 25322-68-3
Thiodiglycol, C₄H₁₀O₂S, CAS No. 111-48-8
Glycerol, C₃H₈O₃, CAS No. 56-81-5

Sodium hydroxide
NaOH/CAS No 1310-73-2

Paraffin
CₙH₂ₙ₊₂/CAS No. 8012-95-1

Desiccant Silica Gel Blue
SiO₂/CAS No. 7631-86-9

Double distilled water
ddH₂O/CAS No. 7732-18-5
Magnetic stirrer with heating plate, photometer, centrifuges
One- and two-neck round bottom flasks, crystallization dish, drying tube, centrifuge tube (50 ml), dialysis tube (exclusion size 3.5 kDa)

### Structure:

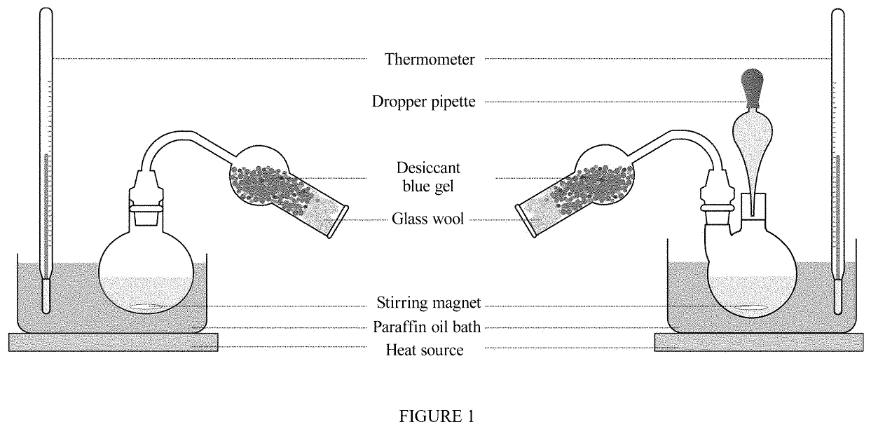

For alcohols with a boiling point above 100° C.: A 50 ml round bottom flask with stirring magnet and drying tube (drying agent: Silica Gel Blue) are placed in a paraffin oil bath on a magnetic stirrer with heating plate (see FIG. 1 left).

For alcohols with a boiling point below 100° C.: A 50 ml two-neck flask with stirring magnet and drying tube (drying agent: Silica Gel Blue) are placed in a paraffin oil bath on a magnetic stirrer with heating plate (see FIG. 1, right). The free opening is closed with a ground glass joint.

### Example 2: Performing the Esterification

1. First, 20 ml of an alcohol is added. If the alcohol is present as a solid at room temperature, it is first heated to its respective melting temperature.
2. With constant stirring, 100 mg of lyophilized cyanophycin is added to the alcohol. Cyanophycin is insoluble in most alcohols and forms a white precipitate.
3. A total of 1 ml >96% H₂SO₄ is added drop by drop to the homogeneous suspension with constant stirring.
4. The reaction mixture is heated with constant stirring (paraffin oil bath kept at a constant 70-80° C.) and incubated for several hours.

Incubation period: The exact incubation time varies depending on the alcohol used. The progress of the reaction can be estimated by the turbidity of the reaction mixture. The resulting cyanophycin ester is soluble in the respective alcohol. Once the turbidity of the undissolved cyanophycin has disappeared, most of the reaction has taken place. When the reaction mixture is completely clear, it is incubated for a further hour.

Alcohols with a boiling temperature <100° C.: The heat incubation vaporizes a large volume of the alcohol used. In such a situation, a reflux condenser would be used, but this is unfavorable here. The reaction produces water, which must be removed in order to displace the reaction equilibrium towards the ester (drying tube). Water would also condense in the reflux condenser and thus not be removed efficiently. Therefore, fresh alcohol is constantly added drop by drop over the incubation period—the second opening of the two-necked flask is used for this purpose (FIG. 1, right).
5. After incubation, the reaction mixture is slowly cooled to room temperature. In the next step, the ester is purified from the reaction mixture.

### Example 3: Cleaning by cold precipitation

1. The reaction mixture is incubated for 12 h at −80° C.
2. The preparation is centrifuged at 30,000×g for 45 min at −10° C. (Do not interrupt the cold chain)
3. The polymer pellet is overlaid with −20° C. cold 100% ethanol or propanol and centrifuged again (30,000×g, 40 min, −10° C.). Repeat this washing step again.
4. Dry the polymer pellet in the air at room temperature.

### Example 4: Purification by dialysis

If the cyanophycin ester remains in solution after several hours of incubation at −80° C. or if the alcohol crystallizes out, the reaction product is purified by dialysis. This requires the alcohol to be miscible with water.
1. The reaction mixture is cooled to 4° C.
2. Add 10 ml, 4° C. cold ddH₂O with constant stirring.
3. The reaction mixture, which is in an ice bath, is then neutralized by adding NaOH (pH 7). Care must be taken to ensure that the cold chain is not interrupted. From the addition of ddH2O, neutralization must be fast in order to minimize acid hydrolysis. The pH must also not become alkaline in order to avoid alkaline hydrolysis.
4. If the pH is stable for several minutes, the totality of the reaction mixture is filled into a dialysis tube (cut-off 3.5 kDa).
5. Dialysis is performed against demineralized water in a flow-through dialysis process. The flow rate is 1-2 L/h for 24 hours.
6. The dialyzed reaction mixture is then dried in a Petri dish at 60° C. in a drying oven.

### Example 5: Proof of successful esterification

### Uv-Vis Spectrum

Cyanophycin and its derivatives have a maximum absorption at 200-210 nm due to their peptide bonds.

### SDS-PAGE

Esterification can have an effect on the molecular weight distribution or polydispersity, which can be visualized by SDS-PAGE.

### Horizontal Native Polyacrylamide Gel Electrophoresis

Horizontal native polyacrylamide gel electrophoresis is a new method for validating the net charge of polymers. Unmodified cyanophycin is an ampholyte due to its two free functional groups: guanidine and the carboxy group. The esterification, in which the carboxy group is involved, removes the negative charge, which is why the cyanophycin esters are purely polycations.

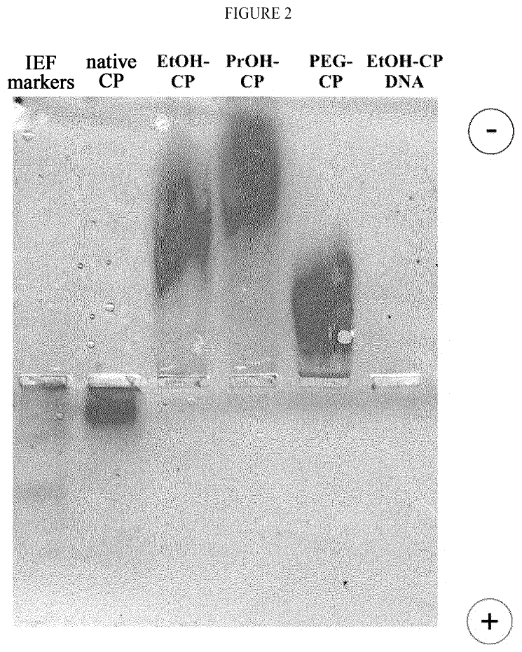

In this method, a native polyacrylamide gel is poured into a horizontal casting device. The comb for the sample pockets is placed in the center of the gel. The gel has a pH of 8.8, and the running buffer has a pH of 8.3. The isoelectric point (IP) of native cyanophycin is between 5.3 and 6. If the pH is above the IP, the polymer is negatively charged and flows to the anode, which is what happens in the case of native cyanophycin. The modified esters, on the other hand, are positively charged even at this high pH and migrate to the cathode. This experiment shows that the modification has changed the net charge of the polymer (see FIG. 2).

### Example 5: Properties of the Inventive Cyanophycin Esters

Native cyanophycin is an ampholyte due to its two free functional groups: guanidine and the carboxy group. Esterification, in which the carboxy group is involved, removes the negative charge. Therefore, a change in the isoelectric point (IP) of the cyanophycin esters is to be expected. For this reason, we performed isoelectric focusing (IEF). Here, the polymers are separated electrophoretically in a pH gradient and collect at the location in the gradient where their net charge corresponds to zero (=the isoelectric point). By removing the negative charges, the cyanophycin esters would be expected to undergo a displacement of the IP to the basic area.

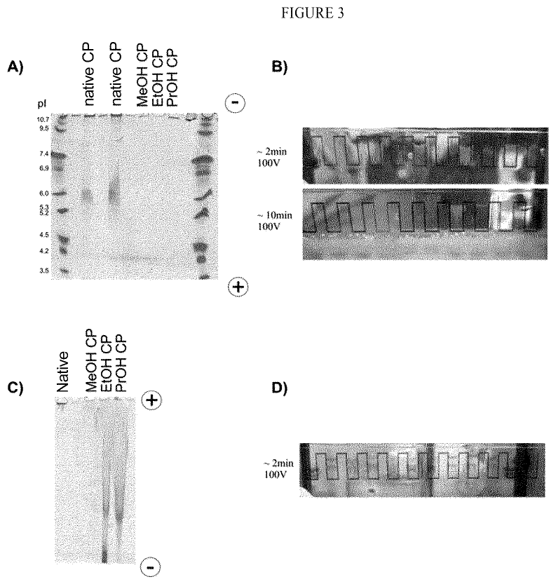

The IP of unmodified cyanophycin is between 5.3 and 6 (FIG. 3A). The water-soluble cyanophycin esters (methanol, ethanol and propanol esterified) tested in this study could not enter the gel (FIG. 3A). Just a few minutes after applying the electric field, it became visible that the esters formed a white streak and migrated in the opposite direction (towards the cathode) (FIG. 3 B). The loading dye (neutral red) ran normally into the gel (towards the anode).

Another IEF was performed, but with the polarity reversed (FIG. 3 C & D). Due to the reversed polarity, unmodified cyanophycin, the loading dye (FIG. 3 D) and the marker could not enter the gel, but the esters could.

The opposite running direction of the cyanophycin esters clearly shows that the esterification was able to remove the negative charges and that these derivatives are therefore no longer ampholytes, but pure cationic polymers.

### Example 6: Production of PEG-cyanophycin

In the so-called “PEGylation” process, compounds are conjugated with polyethylene glycol (PEG). This method has been in use since the 1970s and is often used to modify biopharmaceutical active ingredients or diagnostics (Turecek et al. 2016). PEGylations are also frequently performed on non-viral vectors or carrier substances for gene therapies (Grun et al. 2021). It was observed that such a modification of polyplexes (complex of nucleic acid and a polycationic polymer) can lead to reduced toxicity and increased stability.

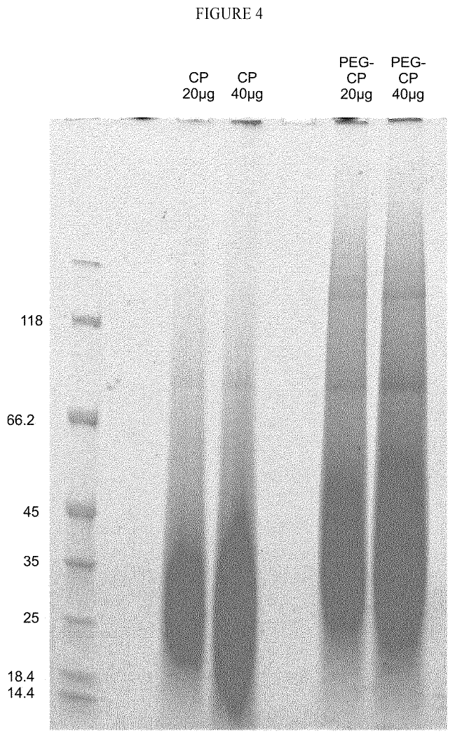

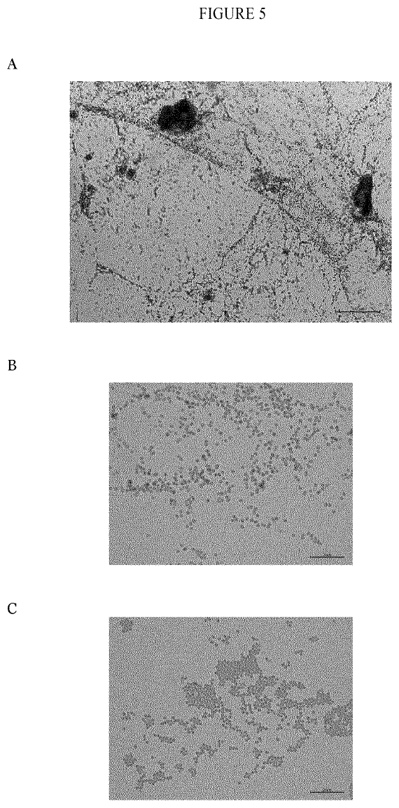

Due to its terminal hydroxy groups, it is also possible to esterify cyanophycin with PEG using the inventive method. In the context of the present invention, it was possible to produce PEGylated cyanophycin. The polymer is highly soluble in water and has a high molecular weight (20 kDa->100 kDa) (see FIG. 4).

### Example 7: Use in case of transfection

Polycationic substances have various possible applications, such as use as transfection reagents. Transfection by means of polycationic substances is already established in many areas.

In a first area, Electrophoretic Mobility Shift Assays (EMSA) were used to show that an interaction between cyanophycin and nucleic acids takes place and that the stability of the complex is pH-dependent. While native cyanophycin only formed stable complexes in the EMSAs at acidic pH (≤2.5), it was possible to form stable complexes with ethyl cyanophycin even at pH 6, leading to a gel shift.

Cationic lipid transfection is one of the most widely used methods for inserting foreign DNA into eukaryotic cells. This method is based on an artificial liposome envelopes the nucleic acid and fuses with the cell membrane.

Invitrogen AG markets a wide range of products for cationic lipid transfection: series: (Lipofectamine™ “https://www.thermofisher.com/de/de/home/brands/product-brand/lipofectamine.html?gclid=EAlalQobChMI8tjlopr08AIVBuh3Ch0IWQ6d EAAYASAAEgLxGPD_BwE&ef_id=EAlalQobChMI8tjlopr08AIVBuh3Ch0IW Q6dEAAYASAAEgLxGPD_BWE: G: s&s_kwcid=AL!3652!3!361762381361!b!! g!% 2Blipofectamine&cid=bid_clb_tfx_r01_co_cp0000_pjt0000_bid00000_0s e_gaw_nt_pur_con)”

According to the supplier, currently the most efficient kit for lipid transfection is the Lipofectamine™ 3000 reagent. According to the manufacturer's protocol, the nucleic acid is first incubated with a polycationic substance (P3000). Lipofectamine is subsequently added, which envelops the complex in a lipid vesicle. In a first experiment, it was tested whether it is possible to replace the cationic P3000 with one of the cyanophycin derivatives produced by the invention. Due to its good solubility at neutral pH, ethyl cyanophycin was therefore used. In the tests, a GFP-encoding plasmid was used as the test nucleic acid to be transfected. Classical lipofection by means of Lipofectamine 3000 resulted in an efficiency of 30.7%. When replacing the cationic P3000 completely with ethyl CP, 39.8% of the cells were positive, which is an increase of approximately 30% compared to the control. As expected, no positive cells were detected in the negative control, in which only ethyl CP with plasmid DNA was used (without lipofectamine). Lipofectamine and P3000 are known to have a cytotoxic effect. An important question was therefore whether ethyl CP has a less cytotoxic effect. An initial microscopic analysis showed that ethyl CP is less toxic than P3000. In the approach in which ethyl CP was used, fewer dead cells were observed.

### Example 8: Properties and Applications of CP Esters According to the Invention

A propyl CP ester (—O-CH2—CH2—CH3) prepared according to the invention was purified and tested for properties for various uses.

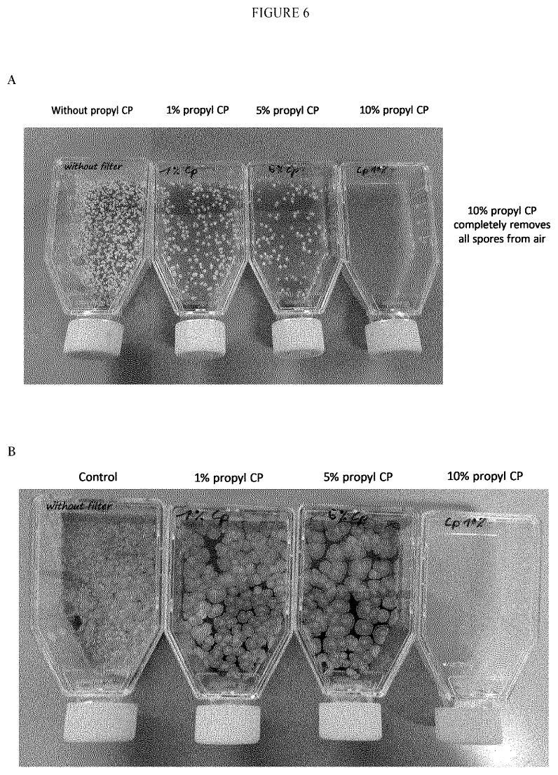

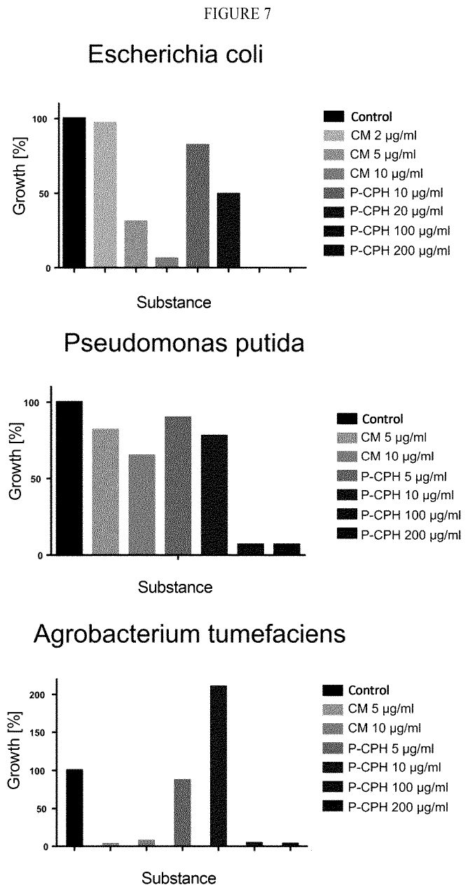

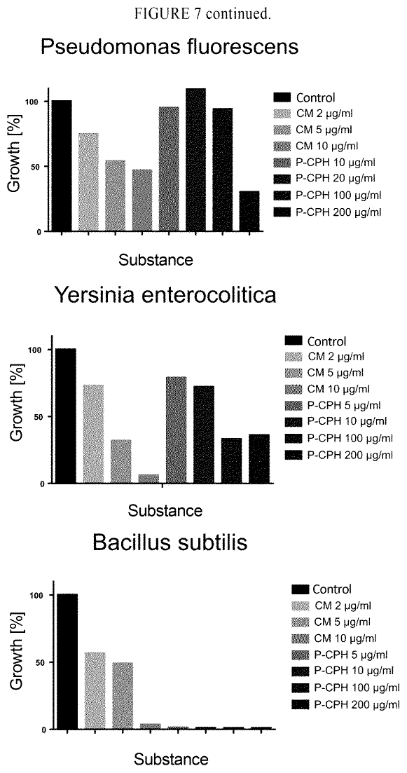

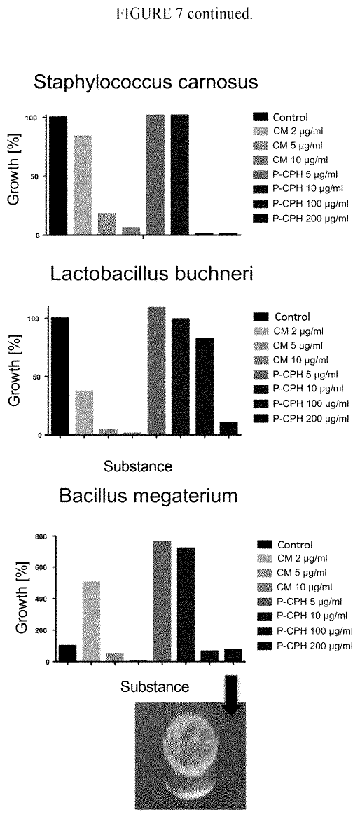

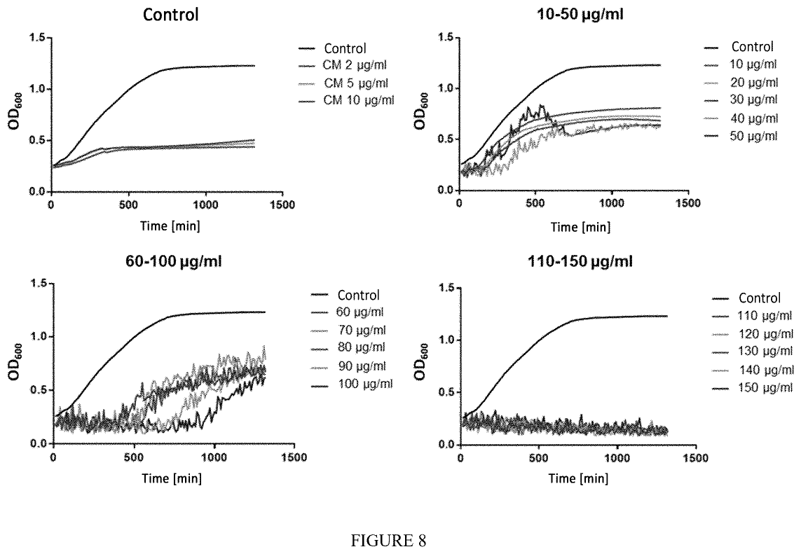

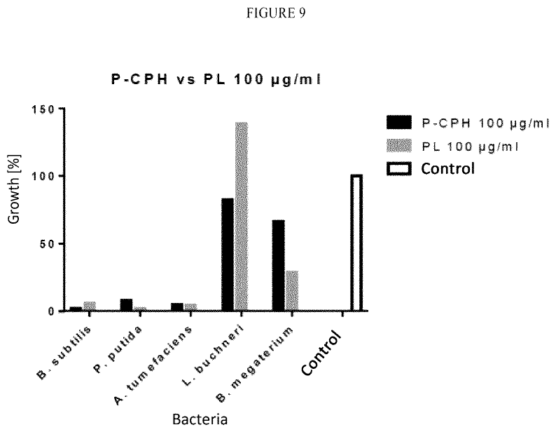

In particular, FIGS. 5-9 show both the property of propyl CP as a cell adhesion mediator and as a growth inhibitor (glues the cells together). The properties of propyl CP correspond to those of the well-known polylysine. Accordingly, a propyl CP is an alternative for all applications in which polylysine is also used.

### REFERENCES

The references are:
Turecek, Peter L., et al. “PEGylation of biopharmaceuticals: a review of chemistry and nonclinical safety information of approved drugs.” Journal of pharmaceutical sciences 105.2 (2016): 460-475.
Grun, Molly K., et al. “PEGylation of poly(amine-co-ester) polyplexes for tunable gene delivery.” Biomaterials 272 (2021): 120780.

1. A method for producing an ester of a cyanophycin polymer or an ester of a cyanophycin polymer derivative, comprising reacting the cyanophycin polymer or the cyanophycin polymer derivative with an alcohol (HO—X) to form an ester of a cyanophycin polymer or an ester of a cyanophycin polymer derivative, and water, under reaction conditions, which allow esterification of the alcohol with at least the carboxyl group of a cyanophycin monomer, wherein the at least one cyanophycin monomer is a component of the cyanophycin polymer or the cyanophycin polymer derivative.

2. The method according to claim 1, wherein within the cyanophycin polymer or cyanophycin polymer derivative at least two cyanophycin monomers are esterified with different alcohols.

3. The method according to claim 1, wherein the cyanophycin polymer has the structure (I), with n>2, preferably with n>8, further preferably with n=50-500 (or 70-350):

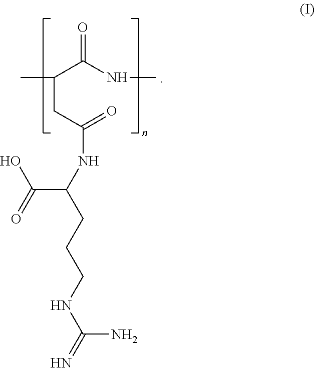

4. The method according to claim 1, wherein the alcohol HO—X is selected from a primary alcohol, such as methanol, ethanol or 1-propanol; mercaptoethanol, glycerol or a polyethylene glycol (PEG), or other secondary or tertiary alcohols.

5. The method according to claim 1, further comprising a step of purifying the ester of a cyanophycin polymer or the ester of a cyanophycin polymer derivative.

6. The method according to claim 1, wherein the cyanophycin polymer has at least nine or more monomers, and wherein the reaction conditions are selected in such a way that at least the carboxyl groups of nine or more monomers are esterified, preferably more than 50% of the carboxyl groups are esterified.

7. An ester of a cyanophycin polymer, according to a structure of the formula (II) with n>2, preferably with n>10, further preferably with n=50-500 (or 70-350): 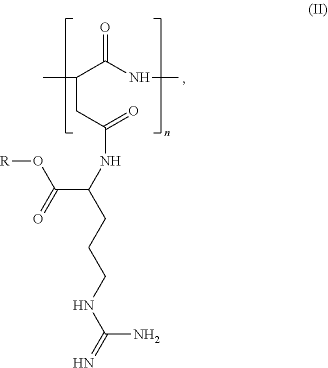
wherein R is selected from a primary, secondary or tertiary alcohol.

8. A method for the production of a pharmaceutical composition, the method comprising a step admixing a cyanophycin polymer of claim 7 as a carrier and/or excipient together with a therapeutically active ingredient.

9. A pharmaceutical composition comprising a therapeutically active ingredient and an ester of a cyanophycin polymer according to claim 7, and, optionally, at least one further carrier and/or excipient.

10. A method of transfecting a nucleic acid into a biological cell, wherein the method comprises a step of admixing the nucleic acid with a cyanophycin polymer according to claim 7 as transfection agent.

11. A method of producing a composition or composition material, wherein the method comprises a step of combining a cyanophycin polymer according to claim 7 as a component in
(i) a coating material, preferably for nanoparticles: or
(ii) in polymer alloys, polymer blends or copolymers: or
(iii) polyelectrolyte multilayers (PEMs): or
(iv) a polyelectrolyte bridging method.
